(19) United States
(12) Patent Application Publication
(10) Pub. No.: US 2006/0053976 A1
(43) Pub. Date: Mar. 16, 2006

(54) Tire cuff

(76) Inventor: David Andrew Fleming, Tumwater, WA (US)

Correspondence Address: David Andrew Fleming, 1015 Lake Park Dr. S.W., Tumwater, WA, 98512, US

(21) Appl. No.: 10/940,295

(22) Filed: Sep. 13, 2004

(51) Int. Cl. B60C 27/06

(52) U.S. Cl. 81/15.8

(57) ABSTRACT

A device to clamp on a tire to hold chains in place while the tire is rotated, allowing the chains to encircle the tire removing all the slack that is inherent in the “drape” method of chain installation on commercial vehicles. This device does not necessitate aligning itself with any holes in the rim of the tire.

### BACK GROUND OF INVENTION

After driving commercial vehicles for thirty years, it is my intention to create a device that allows for the chaining up of both single and multiple axle commercial vehicles quickly and safely. This skill of chaining up commercial vehicles is usually self-taught, often creating an intimidation situation, especially for the new truck driver. The main problem being that the chains are installed with too much slack allowing the chains to slide off, leaving the vehicle susceptible to loss of tractions, or the fall to the inside of the tire and wrap themselves around the axle causing damage to the chains or vehicle. Most commercial drivers use what is called the “drape” method of installation, in which the chains are draped over the top of the tire and then the vehicle is moved forward or backward so that the chains go under the tire and then are physically lifted up to fasten the end pieces. The problem with this method is the amount of slack that is created in the chains during the process. The chains need to be fastened and then rolled forward a short distance to remove the slack, then the driver must get out of the truck and come back a second time and retighten the chains by re-fastening the end pieces, taking up the slack and using rubber tighteners on the sides of the tire.

One advantage of a single bent metal rod in the shape of the tire is that 85% to 90% of the commercial trucks on the road today use the same size tire, making it much easier to simply slip the apparatus over the tire and through the chains without having to fumble with awkward adjustments in freezing cold weather. The shape allows for sufficient clamping force against the sides of the tire to hold the chains in position as the tire is rotated. A single unit device will preclude the possible problem of pieces separating and/ or crimping under the weight of a commercial vehicle. This is a possible drawback to multiple piece devices.

### BRIEF SUMMARY OF INVENTION

An apparatus for grasping and holding tire chains for commercial vehicles. This is for use in the installation of either cable or chain type traction devices on commercial vehicles, by allowing the chains to be held against the tire by a self-clamping device. As the tire is rotated, all slack from the chains is removed allowing for easy connection of the end pieces for a quick, safe and secure installation. Without removing all slack in the chains, the chains may slide off the outside of the tire causing loss of traction, or sliding to the inside, wrapping around the axle and causing damage to the chain and vehicle.

### DESCRIPTION OF DRAWINGS

FIG. 1: Shows a perspective view of the preferred form of the invention.

FIG. 2: Shows the starting position for putting chains on multiple-axle vehicles.

FIG. 3: Shows the finished position with the end links of the chain ready to be joined together with all slack removed.

### DETAILED DESCRIPTION

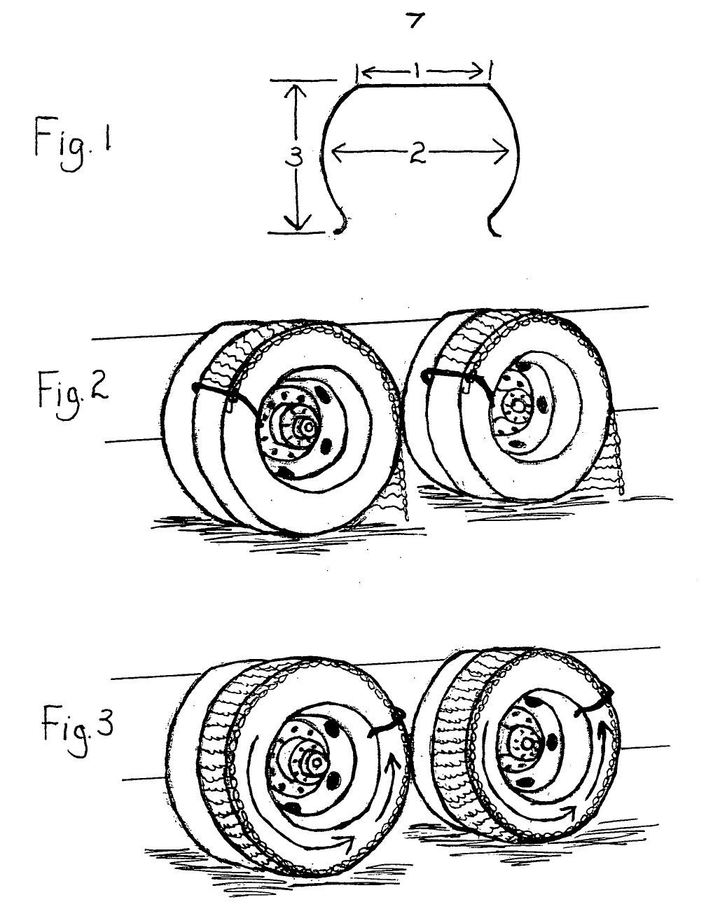

The tool is composed of a bent metal rod in the shape of an upside-down U. The top is flat as shown in FIG. 1, number 1, and extends one quarter of an inch beyond the tread of the tire. The sides extend out to the cross sectional distance of the tire. The height of the tool is the perpendicular distance from the rim to the outside edge of the tire as shown in FIG. 1, number 3. The shape of the tool allows it fit over the exterior of the tire and through the opposing links of the tires chain that are already positioned on the tire, see FIG. 2. The tire is then rotated three quarters of a turn and the chains are pulled around, encircling the tire while remaining in contact with the tire, and removing all of the slack out of the chain. The connecting ends may then be joined together and the chain has been installed in one easy motion, see FIG. 3. It is also shows how multiple axles may be chained up at the same time. It should be obvious to those skilled in the art how to make and adapt this tool to any size commercial vehicle's tire.

I claim that:

1: This tool is used in removing the slack, inherent in the drape method for installing chains on a commercial vehicle.

2: By using one tool per tire, it is possible to chain up multiple axles at the same time. By using this tool a driver may chain as many axles as the tractor and trailer have, all at the same time with only one rotational movement of the vehicles tires. In other words, you move the vehicle once and all the chains n the axles are ready to be secured.
